(19) United States
(12) Patent Application Publication
(10) Pub. No.: US 2026/0126342 A1
(43) Pub. Date: May 7, 2026

(54) METHOD AND APPARATUS FOR TESTING COMPOSITE OPTICAL COMPONENTS

(71) Applicant: SCHOTT AG, Mainz (DE)

(72) Inventors: Volker HAGEMANN, Mainz (DE); Sergej KUNZ, Mainz (DE); Steffen RICHTER, Mainz (DE)

(73) Assignee: SCHOTT AG, Mainz (DE)

(21) Appl. No.: 19/325,992

(22) Filed: Sep. 11, 2025

(30) Foreign Application Priority Data
Sep. 12, 2024 (DE) 10 2024 126 197.8

(51) Int. Cl. G01M 11/02; G01M 11/00

(52) U.S. Cl. CPC G01M 11/0264; G01M 11/005; G01M 11/0214

(57) ABSTRACT

The invention relates to a method and an apparatus for testing the optical properties of a composite optical component which includes a multiplicity of connected transparent elements and reflection layers which are arranged so that light introduced at an input portion is split in a first segment of the composite component with a plurality of transparent elements into a multiplicity of first partial beams, which are guided along different paths in the composite component. The first partial beams are partially reflected multiple times in a second segment which also includes a plurality of transparent elements, so that a plurality of second partial beams emerges from a side face due to the partial reflection. The second partial beams are recorded by a detector, and a quality coefficient is ascertained for a plurality of second partial beams selected according to an aggregation rule so the quality coefficient is assigned to a particular part of the composite component.

### CROSS REFERENCE TO RELATED APPLICATIONS

This application claims the benefit of priority from German Patent Application No. 10 2024 126 197.8, filed Sep. 12, 2024, the disclosure of which is incorporated herein by reference.

### FIELD OF THE INVENTION

The invention relates in general to the production of composite optical components comprising a multiplicity of optical elements, which are joined to one another and in which light is conveyed and deviated by reflexion. In particular, the invention relates to the testing of such composite optical components in respect of the optical quality of such components.

### BACKGROUND OF THE INVENTION

So-called “augmented reality” applications use special spectacles which can overlay additional information items into the user's field of vision via optics. These information items are typically introduced via a projector into the spectacle lens, guided by light-guiding along the spectacle lens and subsequently output, and thus made visible to the user. Various optical elements, which are coupled to one another in the spectacle lens, are provided for the introduction, the light-guiding and the output.

Such spectacle lenses are known for example from EP 1 562 066 B1, US 2023/0314689 A1 and WO 2021/001841 A1. These spectacle lenses, which are formed as image waveguides, may be produced by adhesively bonding a multiplicity of optical parts that have reflective, in particular partially reflective, layers with which the image information items, for example introduced via a projector, are split into a plurality of partial beams, guided in the waveguide and subsequently output in a distributed fashion so that the observer can perceive the image information in addition to the image of the environment. Both the geometrical accuracy of the individual parts and also, in particular, the formation of reflective layers and the mutual alignment of the parts may influence the optical properties of the waveguide in respect of the imaging quality. For example, the modulation transfer function (MTF) may be negatively influenced by tolerance-affected alignment and surface quality of individual parts and layers, which leads to a reduction of the image definition. Here, it would be desirable not only to determine quality factors such as the MTF, but in the event of a poor quality factor also to be able to ascertain which parts of the composite optical component are the cause. This is the object of the present invention.

### SUMMARY OF THE INVENTION

In order to achieve the object, a method for testing the optical properties of a composite optical component is provided. The composite component comprising a multiplicity of transparent elements, which are connected to one another, and reflection layers, wherein the transparent elements and the reflection layers are arranged so that light introduced at an input portion is split in a first segment of the composite component comprising a plurality of transparent elements into a multiplicity of first partial beams, which are guided along different paths in the composite component, and wherein the partial beams are partially reflected multiple times in a second segment, likewise comprising a plurality of transparent elements, in such a way that a plurality of second partial beams emerge from a side face due to the partial reflection, wherein
the second partial beams are recorded by means of a detector, and
a quality coefficient is ascertained, in particular calculated, from the signals of the detector for a plurality of second partial beams, and wherein
the plurality of second partial beams, from the signals of which the quality coefficient is calculated, are preferably selected according to an aggregation rule so that the quality coefficient can be assigned to a particular part of the composite component.

A corresponding apparatus for carrying out this method comprises a mount for a composite component and a light source, which is arranged in relation to the mount so that light of the light source, which is introduced at an input portion of the composite component, is split in a first segment of the composite component comprising a plurality of transparent elements into a multiplicity of first partial beams, which are guided along different paths in the composite component, wherein the partial beams are partially reflected multiple times in a second segment, likewise comprising a plurality of transparent elements, in such a way that a plurality of second partial beams emerge from a side face due to the partial reflection, wherein the apparatus comprises
a detector in order to record the second partial beams, and
an evaluation device, the evaluation device being configured
to calculate a quality coefficient from the signals of the detector for a plurality of second partial beams, and for this purpose to select the plurality of second partial beams, from the signals of which the quality coefficient is ascertained, in particular according to an aggregation rule so that the quality coefficient can be assigned to a particular part of the composite component.

Such a part may be a region or portion of the composite component. Particularly preferentially, however, the selection of the second partial beams even takes place in such a way that the quality coefficient can be assigned to a very particular element of the composite component. In particular, such an element may be a particular reflection layer. In a development of the method and of the apparatus, therefore, the second partial beams for ascertaining the quality coefficient are selected so that the light of these selected partial beams has been reflected at a particular reflection layer. This reflection may also relate to a first partial beam, from which the second partial beam originates.

A partial beam in the context of this disclosure need not be a sharp linear light beam, such as may be generated for instance with a laser. In the context of this disclosure, the partial beams may also be pencils of rays. This is the case, for instance, when these partial beams transmit image information items.

As transparent elements for a composite optical component in the context of this disclosure, glass elements may in particular be envisaged. Plastic elements would however also be conceivable, for instance consisting of PMMA or polycarbonate, or plastics such as are generally also used for spectacle lenses.

The invention will be described in more detail below with the aid of the figures and without restriction thereto. Identical reference signs denote identical or similar elements.

### BRIEF DESCRIPTION OF THE DRAWINGS

FIG. 1 shows a composite optical component in an apparatus for testing the optical properties of the composite component.

FIG. 2 shows a composite optical component together with a diagram of a comparison of a plurality of quality coefficients.

FIG. 3 shows a cross section through a composite optical component.

FIG. 4 shows a beam path for an individual first partial beam in a composite component according to FIG. 3.

FIG. 5 shows a simulation of the position of the exit points of second partial beams from the second segment.

FIG. 6 shows a corresponding simulation with partially removed reflection layers in the first segment.

FIG. 7 shows a corresponding simulation with partially removed reflection layers in the second segment.

FIG. 8 shows a corresponding simulation on a composite component without a mixer segment.

FIG. 9 shows a corresponding simulation on a composite component with a mixer segment, with labelled beam exit points that are added due to the presence of the mixer segment in relation to FIG. 7.

FIG. 10 shows a reticle as image information for determining a modulation transfer function and an arrangement of measurement points.

FIG. 11 shows a side view of a composite component and a camera as a detector, as well as the beam path of second partial beams.

FIG. 12 shows values of the modulation transfer function in two mutually perpendicular directions for various colors.

FIG. 13a shows values of the modulation transfer function in a first perpendicular direction at various measurement points; FIG. 13b shows values of the modulation transfer function in a second perpendicular direction at various measurement points.

FIG. 14 to FIG. 16 show contour diagrams of the modulation transfer function.

### DETAILED DESCRIPTION OF THE INVENTION

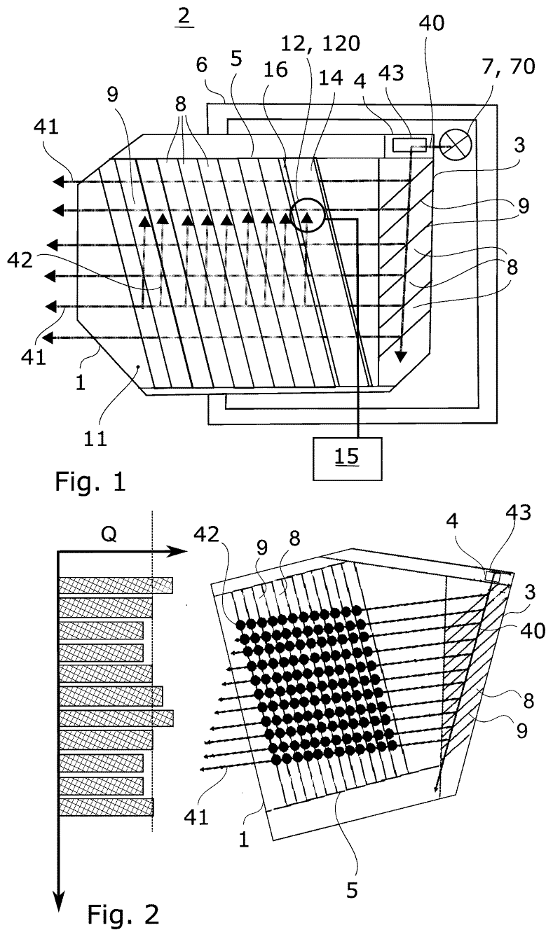

FIG. 1 shows a composite optical component 1, which is suitable in particular as a spectacle lens or screen for augmented reality applications. In order to examine the optical quality, the composite component 1 is in an apparatus 2 for testing the optical properties, or the optical quality, of the composite component 1.

The composite component 1 is composed of a large number of transparent elements 8, which are connected to one another. Generally, without restriction to the example shown, glass elements are preferred as the transparent elements 8. The function of the composite component is also based on the image information, which is intended to be displayed to the user, being split into a large number of different partial beams and delivered in a spatially distributed fashion towards the user's eye. Especially, for this purpose, reflection layers 9 are provided for the splitting. In a preferred embodiment, for this purpose the surfaces of the transparent elements 8 are coated with reflection layers 9. The transparent elements 8 are connected to one another, in particular adhesively bonded, at these coated surfaces. In this way, reflection layers 9 which run inside the composite component 1 are obtained. For the sake of clarity, the adhesive layers are not represented in FIG. 1.

The light, particularly in the form of an image signal for the use of the composite component 1, is introduced via an input portion 40 of the composite component 1. As the light source 7, in a particularly preferred embodiment for the introduction of an image signal, without restriction to the example, a projector 70 for projecting images may be provided.

According to one embodiment, an input mirror 43, which is preferably tilted with respect to the side face 11 of the composite component 1, is provided in the input portion 40. This mirror may likewise be formed as a reflection layer 9. In this way, the light, in particular the image information, can be injected in a direction perpendicular to the side face 11 and is then deviated in the interior of the composite component 1 in a direction along the side face 11. This injected primary beam 40 is split in a first segment 3 of the composite component 1 into a multiplicity of first partial beams 41. During the splitting at the partially reflective reflection layers 9, which are arranged obliquely with respect to the primary beam 40, a deviation of the light also takes place so that the first partial beams 41 are conveyed along different paths in the composite component 1. In particular, these first partial beams 41 may also travel parallel to and at a distance from one another, as in the example FIG. 1. In a second segment 5, the reflection layers 9 lie obliquely with respect to the side face 11 of the composite component 1, so that the light is partially reflected and emerges from the side face 11. Accordingly, the first partial beams 41 are partially reflected multiple times at the reflection layers 9 in the second segment 5, in such a way that a plurality of second partial beams 42 emerge from a side face 11 due to the partial reflection while being spatially distributed over the side face 11. For the sake of clarity, the second partial beams 42 are represented only for one of the first partial beams 41. In order to understand the figure, it should be mentioned that, in a plan view of the side face 11, the second partial beams 42 per se travel substantially in the viewing direction and therefore do not, as represented, travel in the plane of the figure. The same applies for the primary beam 40 between the light source 7 and the input mirror 43. For better representability, a quasi-perspective view has been selected for these beams, so that the beams are visible in the plane of the drawing.

With the method and the apparatus 2 according to this disclosure, it is now possible to examine the optical quality that these second partial beams 42 have. In particular, it is furthermore also possible to ascertain which region, or even which specific element in the composite component 1, is responsible for a possible degradation in the image quality. The evaluation takes place with a detector 12, which is arranged so that it can record the second partial beams 42. Specifically, a camera 120 is provided as the detector 12 here. Connected to the detector 12, or the camera 120, there is an evaluation device 15 which is configured to calculate a quality coefficient from the signals of the detector 12 for a plurality of second partial beams 42, and for this purpose to select the plurality of second partial beams 42, from the signals of which the quality coefficient is ascertained, in particular according to an aggregation rule so that the quality coefficient can be assigned to a particular part of the composite component 1. The plurality of partial beams 42 may be recorded individually in succession, for example by the detector 12 respectively being repositioned by means of a suitable device in order to record a further second partial beam 42. Also, alternatively or in addition, a plurality of second partial beams 42 may be recorded simultaneously by the detector 12.

Generally, but particularly for an embodiment in which a projector 70 is provided as the light source and a camera 120 is provided for the detector 12, for accurate measurement it is favourable that the exit pupil of the light source 7, i.e. preferably of the projector 70, is smaller than the entry pupil of the detector 12, i.e. in particular of a camera 120. In this way, the exit points of the second partial beams 42, and therefore also their optical path, may be on the one hand well defined and on the other hand reliably recorded. Preferably, the entry pupil is larger at least by a factor of 2.

The calculation of the quality coefficient may in general comprise the formation of a sum, and in particular also an average value, of the signals of the detector 12. For example, a quality coefficient may be ascertained for each second partial beam 12 of the selected set. An average quality coefficient may then be determined from the individual values.

If the signals of particular second partial beams 42 are evaluated and other second partial beams 42 are neglected, this may also be understood as an evaluation with a simple weighting of the second partial beams 42 by the weights 0 and 1. It is, however, generally also possible to perform an additional weighting within the set of the second partial beams 42 selected according to an aggregation rule for ascertaining the quality coefficient. In addition to the selection, the aggregation rule may thus involve a weighting in which one or more weights are not equal to one. Without restriction to particular exemplary embodiments, in one development of the method and of the correspondingly configured apparatus, therefore, the signals of the second partial beams 42 are weighted in order to ascertain the quality coefficient. Such a development is expedient for instance when particular second partial beams 42 are influenced more strongly by the optical properties of a part of the composite component 1 than others are.

If the beam path of the second partial beams 42 indicated in the example of FIG. 1 is traced back, it is apparent that all partial beams 42 have been reflected at the same reflection layer 9 in the first segment 3, since these second partial beams 42 are split from a single first partial beam 41 which is reflected at this reflection layer. A quality coefficient that is obtained by assessing the signals of these second partial beams 42 is accordingly influenced by this individual reflection layer 9. In general, without restriction to this specific example, in one preferred development of the method and of the apparatus 2 correspondingly configured for the evaluation, therefore, the second partial beams 42 for ascertaining the quality coefficient are selected so that the light of these selected partial beams 42 has been reflected at a particular reflection layer 9. However, the light of the partial beams 42 also passes through a multiplicity of further optical elements on its way from the introduction of the primary beam to the output at the side face 11. The influence of a particular part of the composite component 1 on the quality coefficient may nevertheless be extracted particularly well if the quality coefficients relating to different sets of partial beams 42 are considered. In general, therefore, in one development of the method and of the correspondingly configured apparatus 2, the quality coefficient is compared with at least one further quality coefficient, which is ascertained from a different set of second partial beams 42. FIG. 2 shows an example in this regard. A composite component 1 similar to FIG. 1 is shown on the right side of FIG. 2. Here, the beam path of all first and second partial beams 41, 42 relating to a primary beam 40 is shown.

The second partial beams 42, which are emitted perpendicularly with respect to the plane of the image, are symbolized by dots. In the example, the primary beam 40 is split in the first segment 3 into eleven first partial beams 41. As in the example of FIG. 1, each of the second partial beams 42 which originates from a particular first partial beam 41 has consequently been reflected at a particular facet, or a particular reflection layer 9, in the first segment 3. Because of the further elements in the beam path, however, the quality coefficient may also be influenced by precisely these further elements. This may nevertheless be compensated for by a comparison. On the left side, for this purpose, a bar chart of the quality coefficients for the sets of second partial beams 42 relating respectively to one first partial beam 41 is represented. Each bar accordingly represents the quality coefficient respectively relating to a row of the resulting matrix arrangement of the second partial beams 42. The aggregation rule, with which the partial beams 42 are selected, in this example consequently consists in respectively selecting second partial beams 42 that have been split from the same first partial beam 41. In the example, all twelve of these second partial beams 42 may be selected. It would also be conceivable to use a subset, for instance only one in three of the partial beams 42. The comparison now shows that, for example, the reflection at the reflection layer 9 closest to the input mirror 43 may be assigned a higher quality coefficient compared, for instance, with the third and fourth reflection layers 9 in this direction. The former quality coefficient lies above the average value, which is indicated as a dashed line, while the reflections at the third and fourth reflection layers give subaverage quality coefficients. With such an evaluation, elements that are inferior with regard to the optical performance may thus be located. If systematic effects are exhibited here, this may optionally be counteracted, and the optical performance be increased, by adapting the production method for the composite component 1.

It is also apparent from FIG. 2 that the influence of the reflection layers 9 of the second segment 5 on the optical performance of the composite component 1 may also be examined in a similar way. In the example, all second partial beams 42 in a column of the matrix distribution of the second partial beams 42 are respectively reflected at the same reflection layer 9 of the second segment 5. In this case, the second partial beams 42 of the individual columns of the matrix distribution of the second partial beams 42 may thus essentially be selected, which accordingly represents a different aggregation rule. The aggregation rule may, however, be somewhat more complex here since, by two reflections, a first partial beam 41 may possibly also give rise to two second partial beams 42 at the same reflection layer 9 in the second segment 5. The precise aggregation rules may nevertheless be obtained by simulation, for example. An examination of the quality coefficients obtained in this way may then take place by comparison in a similar way as already described with the aid of the bar chart.

In general, without restriction to particular examples and types of quality coefficients, in a development of the method and of the apparatus, a quality coefficient may also be determined from at least two previously ascertained quality coefficients. Such a further quality coefficient ascertained from two or more quality coefficients may be referred to as a superordinate quality coefficient. For example, such a superordinate quality coefficient may be a difference, a quotient, a sum or a product of previously determined quality coefficients. An average of the quality coefficients relating to second partial beams 42 that are split respectively from one first partial beam 41 has already been mentioned above. From the diagram in FIG. 2, the variance of the individual quality coefficients Q could for example also be ascertained, or calculated, as a further, superordinate quality coefficient.

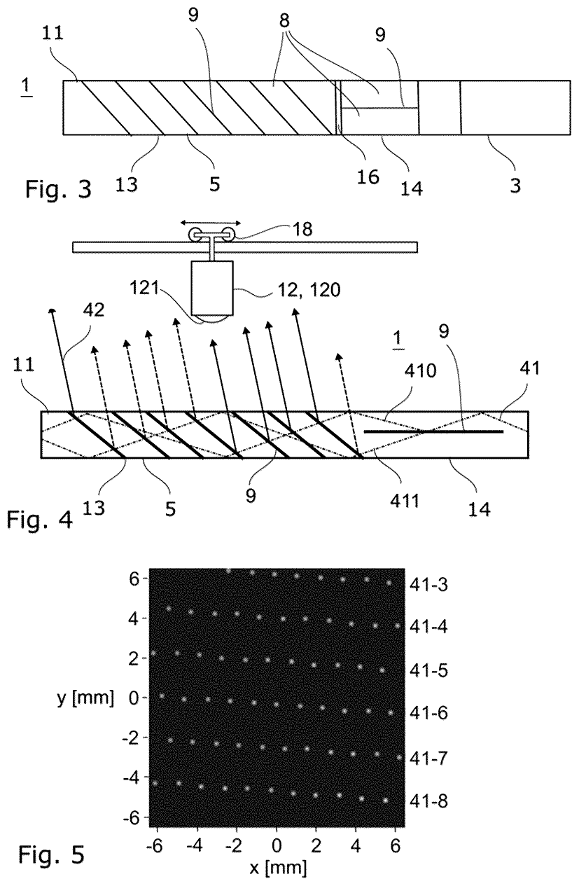

With the aid of FIG. 1 and FIG. 2, the way in which conclusions relating to the quality of individual reflection layers 9 in the first segment 3 and second segment 5 may be drawn by selecting and evaluating the signals of particular second partial beams has been explained. Often, however, such a composite optical component 1 also contains further optical elements. For instance, a partially reflective reflection layer 9 lying horizontally, or extending parallel along the side face 11, may be provided. Such a reflection layer may be used to split the first partial beams so that the split beams are then conveyed on different paths in the second segment 5. Brightness variations may therefore be homogenized. FIG. 3 shows in this regard a composite optical component 1 in cross section. The composite component 1 is typically discoid with parallel side faces 11, 13. Unlike as represented, the composite component 1 may also have a slight curvature. Arranged between the first segment 3 and the second segment 5, with its reflection layers 9 oriented obliquely with respect to the side faces 11, 13, there is a mixer segment 14 with a reflection layer 9 lying parallel to the side faces 11, 13.

The beam path for an individual first partial beam 41 in such a composite component 1 is shown schematically by FIG. 4. As may be seen, a first partial beam 41 is split at the reflection layer 9 of the mixer segment 14 into two partial beams 410, 411, from which second partial beams 42 are then respectively in turn separated at the reflection layers 9 of the second segment 5 and emerge from the side face 11. If the reflection layer 9 in the mixer segment were omitted, the partial beam 410 would be absent. Correspondingly, all second partial beams 42 that start from this partial beam 410 would also be absent. Precisely these second partial beams 42 that start from the partial beam 410 thus contain information relating to the optical quality of the mixer segment 14 and its reflection layer 9. In this case, however, the aggregation rule for selecting the second partial beams would be more complex compared with the selection rules for the reflection layers 9 of the first and second segments 3, 5. In the example of FIG. 4, the second partial beams 42 to be selected are indicated for illustration with a solid line and the partial beams 42 to be neglected are indicated by dashed lines. In this regard, it should be noted that the spatial location of the second partial beams 42, and therefore also the respective aggregation rule, also depend on the path of the first partial beam 41, which in turn depends on the path of the primary beam. In this respect, the representation is purely exemplary. In general, however, without restriction to the example represented, in one development of the method and of the correspondingly configured apparatus 2, the composite optical component 1 has a mixer segment 14 which is arranged before the second segment 5 in the beam direction, preferably between the first segment 3 and the second segment 5, and which has a partially reflective reflection face 9 lying parallel to the side face 11 in the interior of the composite component 1, those second partial beams 42 that are derived from a partial beam 410 reflected at this reflection face 9 being selected for the determination of the quality coefficient.

In order to selectively record the second partial beams 42, in one embodiment of the apparatus, in general a movement device 18 is provided, with which the detector 12 and the composite optical component 1 can be moved relative to one another in order to position the detector 12 at particular measurement positions in relation to the composite optical component 1, particularly in order to scan the side face 11 at the predetermined measurement positions. In the example, the detector 12 is attached to the movement device 18 in order to move it while the composite component 1 is held fixed. The reverse configuration with a moved composite component 1, or a combined movement, are also possible. For an evaluation of image signals, in general and without restriction to the example, it is furthermore preferred for the detector 12 to comprise a camera 120.

The following figures graphically illustrate aggregation rules generated by simulations for the aforementioned reflections at individual reflection faces 9 in the first and second segments 3, 5 and the mixer segment 14.

FIG. 5 shows the brightly represented exit points of the second partial beams 42 on an area of the second segment 5 with a size of 12×12 mm. As may already be seen from the schematic representation of FIG. 2, there are rows of exit points of the second partial beams 42 that are split from the first partial beams 41. The first partial beams 41 are respectively formed, as described, at particular successive reflection layers 9 in the first segment 3. The underlying partial beams 41 are indexed by 41-3 to 41-8 in FIG. 5.

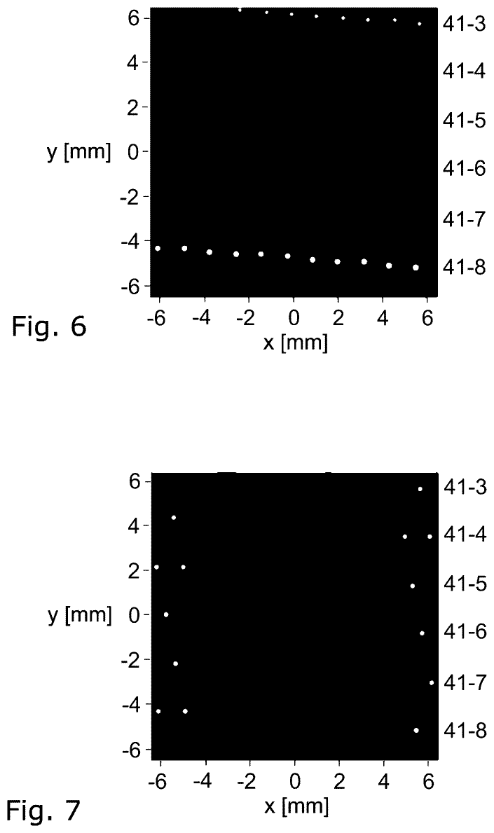

FIG. 6 shows the same simulation with partially removed reflection layers in the first segment 3. Only the reflection layers with the indices 41-3 and 41-8 remain. Correspondingly, there are two rows of exit points of the second partial beams 42.

FIG. 7 was based on a composite component in which all the reflection layers 9 in the first segment are present but there are only two reflection layers 9 of the second segment at the edge of the field of view. As already mentioned, the still existing second partial beams 42 to be selected according to the corresponding aggregation rule are not necessarily arranged exactly in columns of a matrix array. Rather, there are slight displacements of the exit points in the x direction due to the beam path, as well as multiple second partial beams 42 from one first partial beam 41. Nevertheless, the pattern shown may be used as an aggregation rule for a primary beam incident in accordance with the simulation, in order to test the optical quality of the respective reflection layers 9 of the second segment 5.

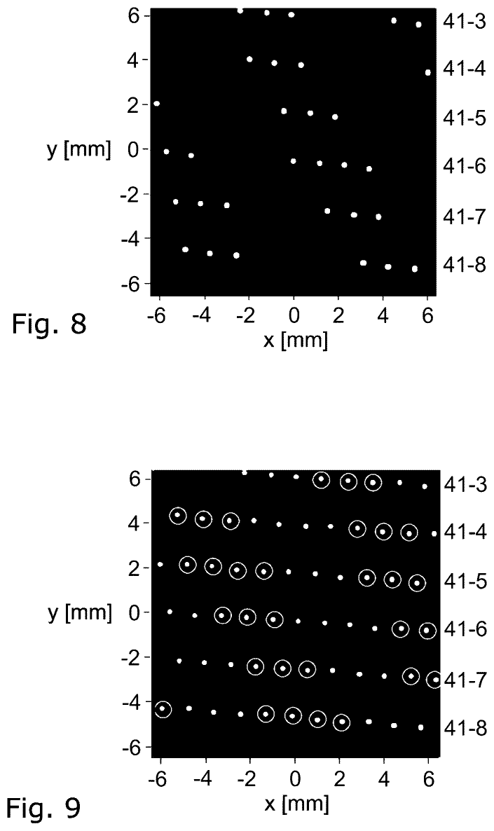

FIG. 8 shows a corresponding simulation on a composite component 1 without a mixer segment 14, or its reflection face running parallel to the side face 11. As may be seen, in relation to the simulation of FIG. 5 on a composite component 1 with a mixer segment 14, groups of second partial beams 42 are absent along obliquely running strips. The effect is readily apparent when considering the schematic beam path in FIG. 4. FIG. 9 shows a corresponding simulation on a composite component with a mixer segment 14, i.e. the same simulation as in FIG. 5. Here, however, those second partial beams that are added in relation to FIG. 8 are labelled with circles around the beam exit points. These marked second partial beams accordingly correspond to an aggregation rule in order to test the optical quality of the mixer segment with the aid of a quality coefficient. A relative comparison may take place similarly as in FIG. 2 by ascertaining the quality coefficient with the second partial beams that can be seen in FIG. 8. Here as well, a superordinate quality coefficient ascertained from the quality coefficients of the sets of partial beams represented in FIG. 8 and FIG. 9 may thus be particularly informative of the quality of the reflection layer in the mixer segment 14. For example, the modulation transfer functions for the subsets of second partial beams 42 that have been transmitted and reflected at the reflection layer 9 may be set in a ratio.

There are many quality coefficients that may be determined with the method and the apparatus 2 according to the method. Inter alia, the following quality coefficients are particularly advantageous for judging the product quality:
the modulation transfer function in at least one image direction, optionally also color-dependent,
a comparison, in particular a ratio, of the modulation transfer functions for two different image directions,
angular deviations of the direction of the second partial beams 42,
the transmission efficiency, in particular also color-dependent,
a displacement of color coordinates,
the dispersion in the emergent second partial beams 42,
the polarization of the second partial beams 42.

Some such quality coefficients, for instance the transmission efficiency, may also be determined by non-imaging measurement methods. For instance, a laser as a light source and a simple detector, for instance a photodiode, would be conceivable. A non-imaging measurement would also be conceivable for the polarization. The polarization of the light is influenced by the reflections at the reflection layers 9. A λ2 plate 16, as shown by the examples of FIG. 1 and FIG. 3, may additionally be provided. This rotates the polarization direction of the light so that an effective reflection at the reflection layers 9 in the second segment 5 is made possible. This plate is very thin, and tolerances may correspondingly cause severe variations of the polarization state. Possible birefringence in the transparent elements 8 is a further effect.

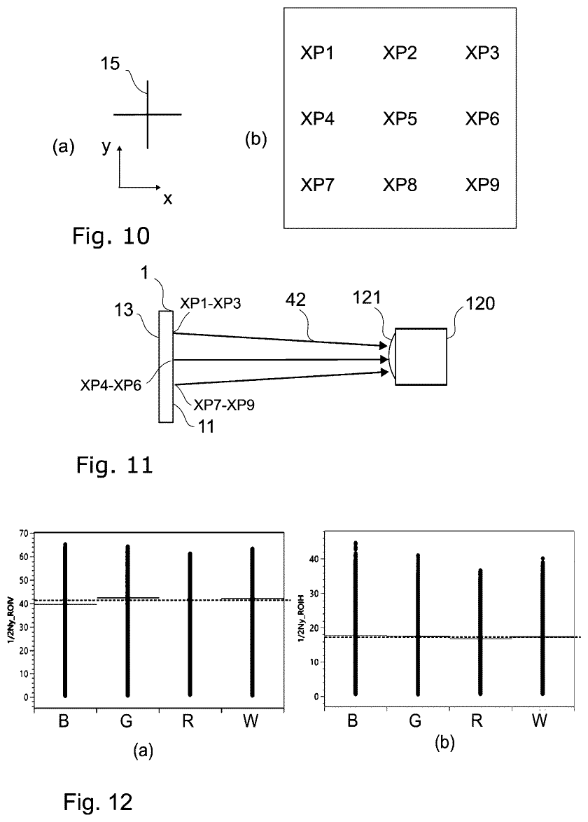

In general, however, as already mentioned for the example of FIG. 1, it is preferable to use a projector 70 to introduce a primary beam 40, which contains an image information item, and to evaluate this image information with a detector 12 in the form of a camera 120. In order to determine the modulation transfer function for a second partial beam 42, an image containing one or more test structures, for example reticles, dots or crosses, may be introduced and the image in the respective second partial beam 42 may be recorded by the camera 120. These images may then be evaluated in respect of their definition in two different image directions, in the case of a reticle for instance perpendicularly with respect to the branches of the reticle, in order to determine the modulation transfer function. Such a reticle 15 with two spatial directions y, x is shown by FIG. 10, partial image (a). Partial image (b) shows a region on the second segment 5 with nine measurement points XP1-XP9, which are used for the further exemplary embodiments. The measurement points lie in a square region with a size of about 17×17 mm.

Each measurement point represents an exit point of a second partial beam 42. The exit points, or the spatial arrangement of the second partial beams 42, are not explicitly selected in the following examples in such a way that the image signal is influenced in isolation by particular elements, for instance a particular reflection layer, and can be assigned thereto. Rather, the measurement points, or the recorded second partial beams, are selected so that they are centred in relation to the eye of a user. These measurement positions can nevertheless be informative of the quality of particular regions of the composite component 1, so that the quality coefficient may be assigned to a particular part of the composite component 1. Thus, the optical path for the measurement point XP3 and the second partial beam emerging there is the shortest, and that for the measurement point XP7 is the longest, since the first segment 3 is arranged to the right of the detail shown and the introduction of the primary beam takes place from the top right, in the vicinity of the measurement point XP3.

As explained with the aid of FIG. 4, the second partial beams 42 emerging from the measurement points XP1-XP9 may be recorded by the detector 12, preferably a camera 120, moving to the measurement positions, or scanning the side face 11, by means of a suitable movement device 18. According to an alternative or additional embodiment, a rapid measurement may moreover take place by all the measurement points XP1-XP9, or the second partial beams emerging there, being recorded together in a camera 120. For this purpose, the camera 120 is arranged at a larger distance so that, as shown in FIG. 11, the partial beams 42 are acquired and imaged by the objective 121 of the camera. The objective 121 may in particular be configured as a telescope. The side view corresponds to a viewing direction from the left onto the arrangement of the measurement points XP1-XP9 as shown in FIG. 10. In the representation, three measurement points as well as their second partial beams 42 accordingly lie respectively above one another. Such an arrangement, in which a plurality of partial beams are recorded simultaneously, is naturally not restricted to this specific example. Combined recording of all the partial beams 42 shown in FIG. 5 at the same time would also be conceivable on condition that the entire region shown can be imaged simultaneously. Without restriction to particular examples, in one embodiment, the detector 12 therefore comprises a camera 120, which is arranged at a distance from the side face 11 of the composite component 1 such that a plurality of partial beams 42 are recorded simultaneously by the camera 120, these second partial beams 42 emerging with a spacing on the side face 11 of at least 10 mm, preferably at least 15 mm. If a plurality of second partial beams 42 are recorded together, as represented in FIG. 11, the projector may also introduce a corresponding test image that contains a plurality of test structures, for instance reticles. For the example of FIG. 10, partial image (b), an image with nine reticles 15 in a 3×3 matrix arrangement may thus be introduced, which are then visible at the respective measurement positions XP1-XP9.

FIG. 12 shows values of the modulation transfer function (MTF) in two mutually perpendicular directions for various colors. Partial image (a) shows the values 1/2Ny_ROIV for the y direction, corresponding to partial image (a) of FIG. 10, and partial image (b) correspondingly shows the values 1/2Ny_ROIH for the x direction. The partial beam from the central measurement point XP5 was evaluated. The measurement values 1/2Ny_ROIV and 1/2Ny_ROIH are a measure of the definition of the imaged reticle 15, indicated in multiples of half the Nyquist frequency of the human eye. Specifically, the values describe the percentage contrast for a pattern with 10 lines per degree of visual angle. The MTF was evaluated for the colors blue, green, red and white, corresponding to the abbreviations B, G, R, W. FIG. 12 shows that the resolution, or the MTF, has scarcely any color dependency for both spatial directions since all the values lie close to the average, which is indicated as a dashed line. However, the values of the MTF differ significantly between the vertical direction (partial image (a)) and the horizontal direction (partial image (b)), a better definition being achieved in the vertical direction. For the following examples of the spatial distribution of the MTF, only the color green was evaluated.

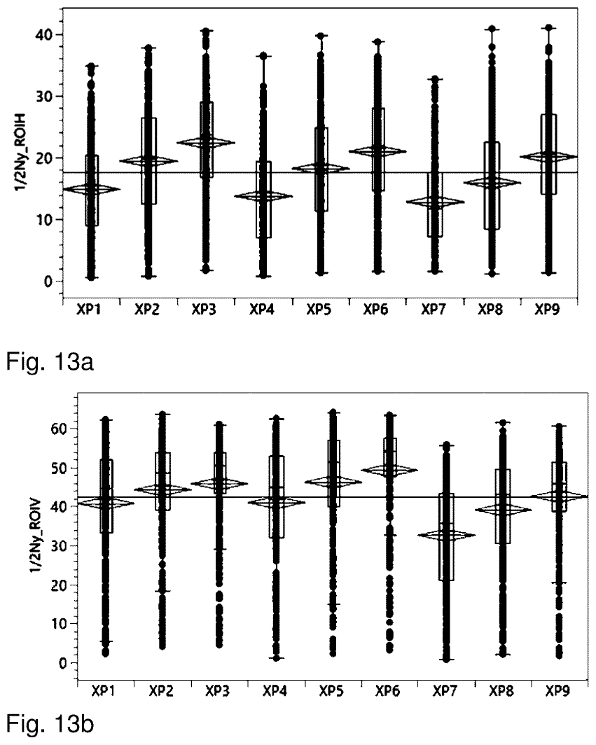

FIG. 13a shows a one way analysis of the values 1/2Ny_ROIV (y direction). A slight decrease in the resolution is exhibited within all rows of measurement points. Thus, the resolution for the measurement points XP3, XP6, XP9 lying on the right at the beam entry into the second segment 5 is the highest within the rows, whereas the resolution for the measurement points XP1, XP4, XP7 lying furthest away is the lowest. Although the measurement points cannot be assigned to particular reflection layers, they do show the influence of the reflection layers 9 of the second segment 5 as a part of the composite component 1. In other words, the measurement values as quality coefficients, and in particular their decrease, can be assigned to the number of reflection layers 9 lying in between.

FIG. 13b shows a one way analysis of the values 1/2Ny_ROIH, (x direction). A slight decrease in the resolution is exhibited within all rows of measurement points. Thus, the resolution for the measurement points XP3, XP6, XP9 lying on the right at the beam entry into the second segment 5 is the highest within the rows, whereas the resolution for the measurement points XP1, XP4, XP7 lying furthest away is the lowest. Although the measurement points cannot be assigned to particular reflection layers, they do show the influence of the reflection layers 9 of the second segment 5 as a part of the composite component 1. In other words, the measurement values as quality coefficients, and in particular their decrease, can be assigned to the number of reflection layers 9 lying in between.

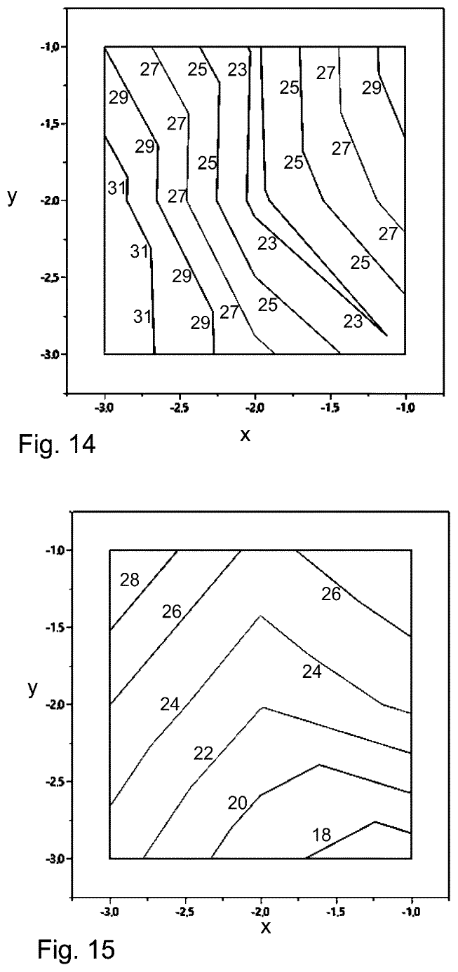

With these measurement values 1/2Ny_ROIV, 1/2Ny_ROIH, contour diagrams of the MTF may also be compiled for a measurement region, as shown in FIG. 10, partial image (b). FIG. 14 shows a contour diagram of the MTF, specifically of the value 1/2Ny_ROIH (i.e. the resolution in the x direction) of a composite component 1 with good optical resolution. In order to understand the diagram, it should be noted that the indexing of the spatial directions in FIG. 14 and the following representations is inverted in relation to the orientation according to FIG. 10, partial image (b). The measurement point XP3 does not lie at the top right in the contour diagram, but at the bottom left. The measurement values are respectively entered on the left next to the contour lines.

Here as well, the best resolution is exhibited in the region of the measurement position XP3, i.e. in this case at the bottom left, which may be seen with the aid of the contour having a value 1/2Ny_ROIH of 31. Interestingly, a slight minimum is to be seen in the middle of the region at a 1/2Ny_ROIH value of 23. A constant decrease in the resolution, as in the example of FIG. 13a and FIG. 13b, is thus not inevitable.

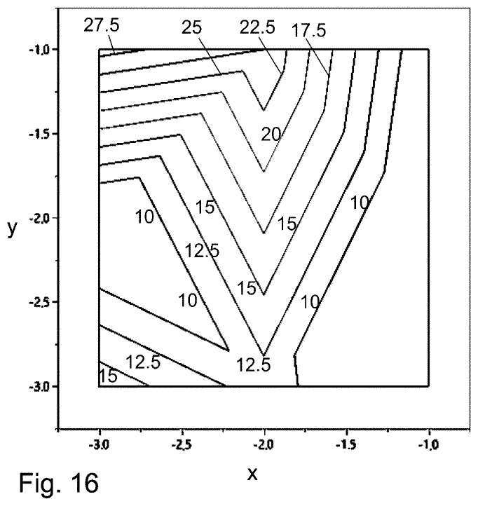

FIG. 15 shows a further example of such a contour diagram. Here, the highest resolution values are found at the top left, which corresponds in FIG. 10, partial image (b) to the region around measurement point XP9. The optical quality may still be judged as being good in respect of the MTF. However, the contour profile suggests a slight degradation in the first segment 3, or one or more of the reflection layers 9 in this part. Specifically, the quality coefficient 1/2Ny_ROIH with the slightly degraded value of 18 may be assigned to the part of the first segment 3 approximately in the vicinity of the input portion 4.

FIG. 16 lastly shows a contour diagram with poor values of the MTF. Overall, the resolution is reduced over a large area to comparatively low 1/2Ny_ROIH values of 10. With correspondingly set minimum requirements, such a composite component 1 could be rejected.

Although the present invention has been described with the aid of preferred exemplary embodiments, it is not restricted thereto but may be modified in a variety of ways.

### LIST OF REFERENCE SIGNS

| | |
|---|---|
| 1 | composite optical component |
| 2 | apparatus for testing the optical properties of a composite |
| | optical component 1 |
| 3 | first segment |
| 4 | input portion |
| 5 | second segment |
| 6 | mount |
| 7 | light source |
| 8 | transparent element |
| 9 | reflection layer |
| 11, 13 | side face of 1 |
| 12 | detector |
| 14 | mixer segment |
| 15 | reticle |
| 16 | λ/2 plate |
| 18 | movement device |
| 40 | primary beam |
| 41 | first partial beam |
| 42 | second partial beam |
| 43 | input mirror |
| 70 | projector |
| 120 | camera |
| 121 | objective |
| 410, 411 | partial beams generated in the mixer segment 14 |

1. A method for testing the optical properties of a composite optical component, wherein the composite component comprises a multiplicity of transparent elements, which are connected to one another, and reflection layers, wherein the transparent elements and the reflection layers are arranged so that light introduced at an input portion is split in a first segment of the composite component comprising a plurality of transparent elements into a multiplicity of first partial beams, which are guided along different paths in the composite component, and wherein the first partial beams are partially reflected multiple times in a second segment, likewise comprising a plurality of transparent elements, in such a way that a plurality of second partial beams emerge from a side face due to the partial reflection, wherein
the second partial beams are recorded by means of a detector, and
a quality coefficient is ascertained from the signals of the detector for a plurality of second partial beams.

2. The method according to claim 1, wherein the plurality of second partial beams, from the signals of which the quality coefficient is ascertained, are selected according to an aggregation rule so that the quality coefficient can be assigned to a particular part of the composite component.

3. The method according to claim 1, wherein the second partial beams for ascertaining the quality coefficient are selected so that the light of these selected partial beams has been reflected at a particular reflection layer.

4. The method according to claim 1, wherein the quality coefficient is compared with a further quality coefficient, which is ascertained from a different set of second partial beams.

5. The method according to claim 1, wherein a superordinate quality coefficient is ascertained from at least two previously ascertained quality coefficients.

6. The method according to claim 1, wherein the composite optical component has a mixer segment, which is arranged between the first segment and the second segment and has a partially reflective reflection face lying parallel to the side face in the interior of the composite component, those second partial beams that are derived from a partial beam reflected at this reflection face being selected for the determination of the quality coefficient.

7. The method according to claim 1, wherein at least one of the following quality coefficients is determined:
the modulation transfer function in at least one image direction, optionally color-dependent,
a comparison, in particular a ratio, of the modulation transfer functions for two different image directions,
angular deviations of the direction of the second partial beams,
the transmission efficiency, in particular also color-dependent,
a displacement of color coordinates,
the dispersion in the emergent second partial beams, and/or
the polarization of the second partial beams.

8. The method according to claim 7, wherein in order to determine the modulation transfer function for a second partial beam, an image having one or more test structures is introduced and the image in the second partial beam is recorded by a camera and evaluated in respect of the definition in two different image directions.

9. The method according to claim 1, wherein the signals of the second partial beams are weighted in order to ascertain the quality coefficient.

10. An apparatus for carrying out the method according to claim 1, comprising a mount for a composite component and a light source, which is arranged in relation to the mount so that light of the light source, which is introduced at an input portion of the composite component, is split in a first segment of the composite component comprising a plurality of transparent elements into a multiplicity of first partial beams, which are guided along different paths in the composite component, wherein the first partial beams are partially reflected multiple times in a second segment, likewise comprising a plurality of transparent elements, in such a way that a plurality of second partial beams emerge from a side face due to the partial reflection, wherein the apparatus comprises
a detector in order to record the second partial beams, and
an evaluation device, the evaluation device being configured
to calculate a quality coefficient from the signals of the detector for a plurality of second partial beams, and for this purpose to select the plurality of second partial beams, from the signals of which the quality coefficient is ascertained, in particular according to an aggregation rule so that the quality coefficient can be assigned to a particular part of the composite component.

11. The apparatus according to claim 10, wherein the light source comprises a projector for transmitting images.

12. The apparatus according to claim 10, wherein the detector comprises a camera.

13. The apparatus according to claim 10, wherein the exit pupil of the light source is smaller than the entry pupil of the detector.

14. The apparatus according to claim 13, wherein the light source is a projector, and the detector is a camera.

15. The apparatus according to claim 10, wherein a movement device, with which the detector and the composite optical component can be moved relative to one another in order to position the detector at particular measurement positions in relation to the composite optical component.

16. The apparatus according to claim 10, wherein the detector comprises a camera, which is arranged at a distance from the side face of the composite component such that a plurality of partial beams are recorded simultaneously by the camera, and the plurality of partial beams are emerging with a spacing on the side face of at least 10 mm.

17. The apparatus according to claim 16, wherein the plurality of partial beams are emerging with a spacing on the side face of at least 15 mm.
